(19) United States
(12) Patent Application Publication
(10) Pub. No.: US 2004/0257987 A1
(43) Pub. Date: Dec. 23, 2004

(54) Robust interactive communication without FEC or re-transmission

(76) Inventors: Nadeemul Haq, San Jose, CA (US); Abulgasem Hassan Aboulgasem, Santa Clara, CA (US)

Correspondence Address: DAVID GIGLIO, ATTORNEY AT LAW, 231 ELIZABETH STREET, UTICA, NY, 13501, US

(21) Appl. No.: 10/873,002

(22) Filed: Jun. 22, 2004

Related U.S. Application Data
(60) Provisional application No. 60/481,008, filed on Jun. 22, 2003.

(51) Int. Cl. H04L 1/00

(52) U.S. Cl. 370/229; 370/235

(57) ABSTRACT

The present invention provides a method for robust interactive multimedia communications without the necessity of forward error correction or re-transmission. Video data is transmitted in the form of spatial packets known as I-frames and temporal packets known as motion vectors and associated prediction errors. The I-frames are inversely coded and stored and utilized as a basis for the motion vectors until a new I-frame is successfully inversely coded. Likewise, the motion vectors are also stored and used to produce P-frames until a new set of motion vectors is successfully transmitted.

A portion of the disclosure of this patent document contains material to which the claim of copyright protection is made. The copyright owner has no objection to the facsimile reproduction by any person of the patent document or the patent disclosure, as it appears in the U.S. Patent and Trademark Office patent file or records, but reserves all other rights whatsoever. This patent application claims priority from provisional patent application 60/481,008 filed on Jun. 22, 2003 by the same inventors which is incorporated herein by reference.

### FIELD OF THE INVENTION

The present invention relates generally to the interactive multimedia communications systems and, more particularly, the a method of providing improved transmission of video data without the requisite of redundancy and re-transmission.

### BACKGROUND OF THE INVENTION

Public networks present many challenges to robust interactive video communication. Effects of network delay, network delay variation, network congestion and noise, available bit-rate variation must all be mitigated to provide acceptable quality of communication.

Re-transmission of corrupted data and redundancy for forward error correction are not viable options due to parametric constraints.

Interactive communication over IP networks in general and Internet in particular present many challenge that must be overcome for robust communication.

Interactive communication requires one-way end-to-end propagation delay to not exceed the generally accepted threshold of 150 mS and round trip delay of 250 mS.

The network delay and bandwidth constraints limit the amount of buffering possible at the receiver.

Available bit-rate on the network can change significantly and abruptly during the duration of a call. This requires an adaptive solution that would vary the compression ratio dynamically to accommodate the compressed coded image over the available bit rate.

Network congestion and errors results in dropped packets. Network noise introduces bit errors in data and control packets.

Because of round trip delay constraints, solutions that employ feed back loops with re-transmission requests are not considered viable. Because of bandwidth limitation, solutions that incorporate forward error correction (FEC) are not desirable.

### SUMMARY OF THE INVENTION

One object of the present invention is to improve the art of communications.

Another object of the present invention is to provide an adaptive solution for robust interactive video communication over public network without the benefit of feedback loops or forward error correction.

One feature of the present invention is to provide a solution that mitigates effects of missing, delayed or corrupted packets without significant cumulative distortion in the received image.

These and other objects and features are provided in accordance with a preferred embodiment of the present invention wherein there is provided a method for transmitting and receiving video data to produce a sequence of timed video frames, wherein the video data includes a plurality of spatial packets and a plurality of temporal packets.

A first set of spatial packets are transmitted from a source and received at a destination. A first set of temporal packets are also received at the destination and stored. The first set of spatial packets are inversely coded to produce a first I-frame.

The first I-frame is then stored and used as the current I-frame. The temporal packets, also known as motion vectors with associated prediction error, are applied to the current I-frame to produce a first set of timed video frames. The current I-frame is constantly re-used until a second set of spatial packets are successfully inversely coded to produce a second I-frame, which is then stored as the current I-frame. The original first I-frame is now discarded from storage.

The first set of temporal packets are now applied to the new current I-frame to produce at least a second set of timed video frames. The first set of temporal packets are constantly re-used until a second set of temporal packets is received and stored, at which time the first set of temporal packets is discarded.

This method allows for efficient transmission of video data without the necessity of re-transmission or forward error correction.

### BRIEF DESCRIPTION OF THE DRAWINGS

No drawings are necessary for an understanding of the present invention.

### DESCRIPTION OF INVENTION

Adaptive Video Codec

Temporal and spatial redundancy in natural video frame sequences is exploited to achieve high degree of compression for optimal use of available bandwidth.

A transmitted video sequence is encoded as a series of packetized reference frames interspersed with motion vectors and associated error packets at the source.

At the destination, reference frames are recovered after decode and inverse transform of received reference frame packets.

Received motion vectors and associated error corrections are applied to the reference frame to generate P-frames. The P-frames are displayed until the next I-frame is received. This cycle is repeated continuously.

Spatial transform packets also known as I-frame packets are generated using two-dimensional wavelet transform and SPIHT coding.

Set partitioning in hierarchical trees (SPIHT) coding introduced by Amir Said and William Pearlman is an effective technique that is used to accomplish embedded coding. The SPIHT algorithm uses the principle of partial ordering by magnitude. It is therefore possible to truncate the transmitted code to match the available bit rate with optimal use of the available bandwidth.

Temporal Redundancy to Compensate for Spatial Corruption

The significant difficulty with embedded coding however is that even a single bit error in transmission could cause the decoder to completely loose track of the code. This makes SPIHT a bad candidate for noisy networks.

One property of the SPIHT coded image is that where a highly localized filter is used to transform the image, a 2×2 block of the SPIHT root are the roots of trees that represent a well defined part of the whole image. For example, when a common intermediate format “CIF” size image (352×288) is transformed and coded, a 2×2 block of the roots represent a 32×32 pixel portion of the whole image.

This very important property is utilized in this invention. The image is broken up into 2×2 blocks at the root. Each block's trees are separately encapsulated in packets. For example a CIF image is subdivided into 99 blocks and encapsulated in separate packets. The effect of a packet loss or corruption is thus localized (isolated). The corrupted packets are dropped, thus no bandwidth is spent on redundancy for forward error correction.

The destination always keeps a copy of the previous I-frame that is updated by motion vectors and associated error corrections for subsequent frames. Utilizing property of natural video, of continuity in scenes, the portion of the image that was lost or corrupted is updated from its copy of previous updated I-frame. Thus temporal redundancy is used to compensate for partial loss of spatial packets.

Mitigating Loss or Corruption of Temporal Information

The image is subdivided into virtual blocks (16×16). Motion vectors and associated errors are generated.

At the source the generated motion vectors and errors are encapsulated in a multiplicity of packets to minimize the impact of corruption.

The packet header contains information regarding the part of image that the packet is applicable to.

The packet consists of the map of a portion of the image whose motion vectors and associated errors are also encapsulated in the packet. Each bit in the map represents a virtual block that is part of the image. A one bit in the bit position on the map indicates presence of motion vector and or error for the corresponding virtual block. A zero indicates no motion vector or error. The rest of the packet is packed with motion vectors and errors of fixed length that occur in the same sequence as the bit map is traversed.

Since a bit error on the map could cause motion vectors and or errors to be applied incorrectly the bit map is protected (with cyclical redundancy checking).

If an error is detected in the bit map of a packet the whole packet is dropped and the sequentially previous motion vector are applied for the same part of image. If the bit error occurs in the portion of motion vector or error information the distortion is tolerated.

Thus minimum redundancy is used for error detection.

Since I-frame is transmitted frequently from source to destination, residual cumulative errors or distortion introduced by application of previous motion vectors is short lived.

Compensating for Delayed Temporal Information

Normally motion vector and error packets are expected to arrive at the destination after typical delay, however it is possible that the packets will be excessively delayed in the network due to congestion or routing. If this happens then a copy of the image before application of motion vector or error compensation is stored. The sequentially previous motion vector or error is applied to the current display.

When the delayed packet arrives at the destination the motion vectors and error compensation are applied to the stored copy and then restored as the current image.

Therefore, there is provided an application which uses set partitioning in hierarchical trees (SPIHT) as part of a video Code/Decoder for interactive multimedia communications over a variable bit-rate network. This method does not require forward error correction or re-transmission of corrupted data, which are tedious especially over noisy networks. The application provided by the present invention provides a method of compensation for excessively delayed data packets, without cumulative distortion.

Various changes and modifications, other than those described above in the preferred embodiment of the invention described herein will be apparent to those skilled in the art. While the invention has been described with respect to certain preferred embodiments and exemplifications, it is not intended to limit the scope of the invention thereby, but solely by the claims appended hereto.

What is claimed is:

1. A method for transmitting and receiving video data to produce a sequence of timed video frames, wherein said video data includes a plurality of spatial packets and a plurality of temporal packets, said method comprising:
transmitting and receiving a first set of spatial packets;
transmitting, receiving and storing a first set of temporal packets;
inversely coding said first set of spatial packets to produce a first I-frame;
storing said first I-frame;
applying said first set of temporal packets to said first I-frame to produce a first set of timed video frames;
re-using said first I-frame until a second set of spatial packets are successfully inversely coded to produce a second I-frame;
storing said second I-frame;
discarding said first I-frame after the production of said second I-frame;
re-applying said first set of temporal packets to produce at least a second set of timed video frames;
transmitting, receiving and storing a second set of temporal packets; and
discarding said first set of temporal packets.
